(19) United States
(12) Patent Application Publication
(10) Pub. No.: US 2025/0334902 A1
(43) Pub. Date: Oct. 30, 2025

(54) IMAGE FORMING APPARATUS

(71) Applicant: CANON KABUSHIKI KAISHA, Tokyo (JP)

(72) Inventors: ISAMU TAKEDA, Tokyo (JP); TAKANORI MITANI, Kanagawa (JP); YUSUKE SHIMIZU, Kanagawa (JP); KOHEI OKAYASU, Shizuoka (JP); MASASHI TANAKA, Kanagawa (JP)

(21) Appl. No.: 19/191,377

(22) Filed: Apr. 28, 2025

(30) Foreign Application Priority Data
Apr. 30, 2024 (JP) 2024-074036

(51) Int. Cl. G03G 15/16; G03G 15/00; G03G 15/20

(52) U.S. Cl. CPC G03G 15/161; G03G 15/2064; G03G 15/50; G03G 2215/00721

(57) ABSTRACT

An image forming apparatus comprises an image carrier that carries a toner image, a secondary transfer roller that performs secondary transfer of a primarily transferred toner image on an intermediate transfer member to a printing medium, and a cleaning device that comes into contact with and separates from the intermediate transfer member and charges and cleans toner remaining on the intermediate transfer member. The cleaning device includes a brush member for charging the toner in accordance with an applied voltage, and the brush member holds toner on a surface of a region thereof that comes into contact with the intermediate transfer member. The image forming apparatus performs control so as to bring the cleaning device into contact with the intermediate transfer member after a leading edge of the printing medium has passed a contact portion between the secondary transfer roller and the intermediate transfer member.

### BACKGROUND

### Field of the Disclosure

The present disclosure relates to an image forming apparatus that forms an image on a printing medium.

### Description of the Related Art

Image forming apparatuses that employ an electrophotographic method perform image formation in which toner images formed on respective electrophotographic photosensitive members are primarily transferred and superimposed onto an intermediate transfer member temporarily, and the superimposed toner image on the intermediate transfer member is then secondarily transferred onto a printing medium by a transfer member that comes into contact with the printing medium in order to transfer the image. By using such image forming apparatuses that employ an electrophotographic method, it is possible to obtain a color image with less physical misalignment (color misregistration) of superimposed component color images.

In order to obtain a favorable image, it is important for an image forming apparatus that uses the aforementioned intermediate transfer member to remove (clean) toner remaining on the intermediate transfer member after secondary transfer in which an image is transferred from the intermediate transfer member to a printing medium, such as paper. For this reason, conventionally, a technique in which a cleaning blade is provided behind a secondary transfer position and residual toner remaining on an intermediate transfer member is scraped off after the secondary transfer has been used. Japanese Patent Laid-Open No. 11-52748 describes a method of cleaning simultaneously with primary transfer, in which residual toner on an intermediate transfer member after secondary transfer is charged to the potential opposite to the charging potential of a photosensitive drum, and the residual toner is collected to a photosensitive drum at a primary transfer nip and primary transfer is performed at the same time.

In this method of cleaning simultaneously with primary transfer, the residual toner after secondary transfer reaches the photosensitive drum, and is then collected by a cleaning unit for the photosensitive drum. For this reason, it is possible to minimize the capacity of a residual toner container for collecting residual toner on the intermediate transfer member, and there is an advantage that the lifespan of the intermediate transfer member can be extended since the intermediate transfer member is not rubbed hard using a blade or the like.

In addition, as in Japanese Patent No. 5954939, charging means for charging residual toner after secondary transfer is configured to be able to come into contact with and separate from an intermediate transfer member, and, when there is no residual toner on the intermediate transfer member, the charging means is separated from the intermediate transfer member. Accordingly, the lifespan of the intermediate transfer member can be further extended. Hereinafter, charging means for charging residual toner after secondary transfer in the above method of cleaning simultaneous with primary transfer is referred to as ICL (intermediate transfer apparatus cleaning) means.

Incidentally, in the above method of cleaning simultaneous with primary transfer, the ICL means aims to charge residual toner after secondary transfer to the potential opposite to the charging potential of the photosensitive drum, but some toner fails to be charged and is collected and held by the ICL means. If the ICL means is a brush, for example, residual toner on the intermediate transfer member after secondary transfer reaches the brush to which the potential opposite to the charging potential of the photosensitive drum has been applied. The residual toner is then charged to the potential opposite to the charging potential of the photosensitive drum and is divided into two members, one passing the brush, and the other failing to be charged to the potential opposite to the charging potential of the photosensitive drum, and being entangled and held on the brush. The toner held on the brush is then ejected onto the intermediate transfer member and is collected on the photosensitive drum at the primary transfer nip by a voltage being applied to the brush at a predetermined timing. Note that, at this time, all of the toner held on the brush is not ejected, and a certain amount of toner is held on the brush. If this held toner scatters to the intermediate transfer member at an unintended timing during image formation, there is the possibility that the scattering toner passes the primary transfer nip, stains a secondary transfer member at a secondary transfer nip, and transfers the stain to a printing medium, which becomes noticeable as an image defect. The above scattering of toner from the brush is likely to occur when the brush is in contact with the intermediate transfer member and the conveyance speed of the intermediate transfer member is changing.

### SUMMARY

Embodiments of the present disclosure eliminate the above-mentioned issues with conventional technology.

Embodiments of the present disclosure provide a technique for preventing toner accumulated on a cleaning portion from scattering onto an intermediate transfer member by separating the cleaning portion from the intermediate transfer member at a timing at which the conveyance speed of the intermediate transfer member is likely to change.

According to embodiments of the present disclosure, there is provided an image forming apparatus that comprises one or more controllers including one or more processors and one or more memories; an image carrier that is configured to carry a toner image; a secondary transfer roller that is configured to perform secondary transfer of a toner image primarily transferred from the image carrier to an intermediate transfer member, from the intermediate transfer member to a printing medium; and a cleaning device configured to be capable of coming into contact with and separating from the intermediate transfer member and to charge and clean toner remaining on the intermediate transfer member after the secondary transfer, the cleaning device including a brush member for charging the toner in accordance with an applied voltage, the brush member holding toner on a surface of a region thereof that comes into contact with the intermediate transfer member, wherein the one or more controllers perform control so as to bring the cleaning device into contact with the intermediate transfer member after a leading edge of the printing medium has passed a contact portion between the secondary transfer roller and the intermediate transfer member.

According to embodiments of the present disclosure, there is provided an image forming apparatus that comprises one or more controllers including one or more processors and one or more memories; an image carrier that is configured to carry a toner image; a transfer unit configured to primarily transfer a toner image formed on the image carrier onto an intermediate transfer member; a secondary transfer roller that is configured to perform secondary transfer of the toner image from the intermediate transfer member onto a printing medium; a cleaning device configured to be capable of coming into contact with and separating from the intermediate transfer member and to charge and clean toner remaining on the intermediate transfer member after the secondary transfer; and a fixing device configured to fix the toner image, secondarily transferred onto the printing medium, to the printing medium by heating and pressurizing the toner image at a fixing nip portion formed between a fixing rotary body and a pressing body pressed against each other. The one or more controllers perform control so as to bring the cleaning device into contact with the intermediate transfer member after a leading edge of the printing medium secondarily transferred by the secondary transfer unit has passed the fixing nip portion of the fixing device.

Further features of various embodiments will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a schematic cross-sectional diagram for describing a schematic cross-sectional configuration of an image forming apparatus according to a first embodiment.

FIGS. 2A and 2B are schematic diagrams showing a schematic configuration of an intermediate transfer belt cleaning device according to the first embodiment.

FIGS. 3A and 3B are schematic diagrams for describing a contact/separated state where the intermediate transfer belt cleaning device is in contact with/separate from the intermediate transfer belt according to the first embodiment.

FIG. 4 is a diagram for describing a control unit of the image forming apparatus according to the first embodiment and a configuration in which the control unit controls contact/separation of an ICL brush.

FIGS. 5A to 5F are schematic cross-sectional diagrams illustrating the position of a toner image on the intermediate transfer belt, the position of a sheet S, and a contact/separated state of an ICL brush, in the image forming apparatus according to the first embodiment.

FIGS. 6A to 6F are schematic cross-sectional diagrams illustrating the position of a toner image on an intermediate transfer belt, the position of a sheet S, and a contact/separated state of an ICL brush, in an image forming apparatus according to a second embodiment.

FIG. 7 is a flowchart for describing contact/separation control of the ICL brush performed in the image forming apparatus according to the first embodiment.

FIG. 8 is a flowchart for describing contact/separation control of the ICL brush performed in the image forming apparatus according to the second embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### First Embodiment

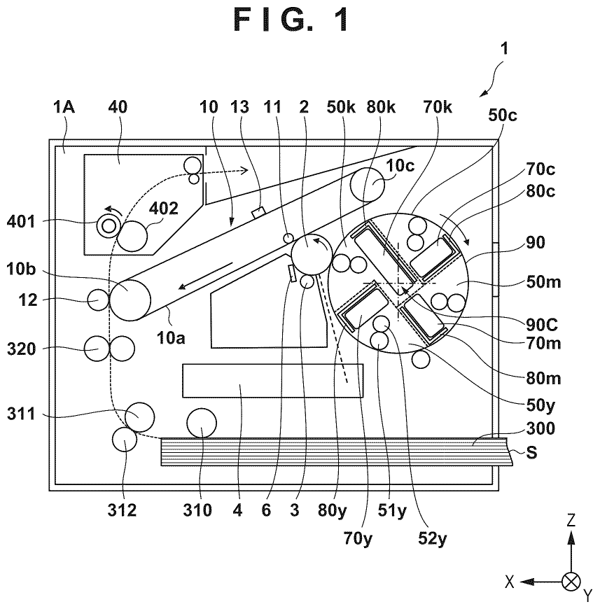

First, a configuration of an image forming apparatus 1 according to a first embodiment of the present disclosure will be described with reference to FIGS. 1 to 4 and 7. In the following description and the drawings, the vertical direction when the image forming apparatus 1 is installed on a horizontal plane is defined as a Z direction. A direction that intersects the Z direction and is the direction of a rotational axis 90C of a later-described rotary body 90 (FIG. 1) (the rotational axis direction of the rotary) is defined as a Y direction. Furthermore, the direction intersecting both the Z direction and the Y direction is defined as an X direction. Here, the X direction and the Y direction are preferably horizontal directions. The X direction, the Y direction, and the Z direction are preferably orthogonal to each other. In addition, as necessary, the directions of the arrows X, Y, and Z illustrated in the drawings are respectively expressed as a +X side, a +Y side, and a +Z side, and the opposite sides to the +X side, the +Y side, and the +Z side are respectively expressed as a −X side, a −Y side, and a −Z side.

FIG. 1 is a schematic cross-sectional diagram for describing a schematic cross-sectional configuration of the image forming apparatus 1 according to the first embodiment.

The image forming apparatus 1 is a laser beam printer that forms an image on a sheet S using an electrophotographic method. More specifically, the image forming apparatus 1 is a color laser beam printer that includes four developing units 50y, 50m, 50c, and 50k. As the sheet S that is a printing material (printing medium), paper such as plain paper and cardboard, plastic films, fabrics, and surface-treated sheet materials, such as coated paper, can be used. A variety of sheet materials with different sizes and materials can also be used, including specially-shaped sheet materials, such as envelopes and index paper.

Next, a schematic configuration and an image forming operation of the image forming apparatus 1 will be described with reference to FIG. 1. As shown in FIG. 1, the image forming apparatus 1 includes an image forming apparatus body (hereinafter, an “apparatus body”) 1A and toner cartridges 70y, 70m, 70c, and 70k detachable to the apparatus body 1A. The apparatus body 1A according to the first embodiment is a portion of the image forming apparatus 1 excluding the toner cartridges 70y, 70m, 70c, and 70k.

The apparatus body 1A of the image forming apparatus 1 includes a drum-shaped (cylindrical) electrophotographic photosensitive member (hereinafter, a “photosensitive drum”) 2 as an image carrier that carries an electrostatic latent image. A charging roller 3, a scanner 4 that is an exposure device, and a cleaning unit 6 for the photosensitive drum 2 are disposed near the photosensitive drum 2.

The charging roller 3 is an example of a charging member for uniformly charging the photosensitive drum 2. The scanner 4 is an example of an exposure member for performing exposure by irradiating the photosensitive drum 2 with laser light that is based on image information. By irradiating the charged photosensitive drum 2 with laser light from the scanner 4, an electrostatic latent image that is based on the image information is formed on the surface of the photosensitive drum 2. The photosensitive drum cleaning unit 6 is an example of a cleaning member for removing toner remaining on the surface of the photosensitive drum 2.

In addition, the apparatus body 1A includes the rotary body (a rotary or a rotating member) 90 that includes the developing units 50y, 50m, 50c, and 50k. In the first embodiment, trays 80y, 80m, 80c, and 80k are attached to the rotary body 90. The toner cartridges 70y, 70m, 70c, and 70k are detachably attached to the trays 80y, 80m, 80c, and 80k.

The developing units 50y, 50m, 50c, and 50k are examples of a developing member for developing (visualizing) an electrostatic latent image formed on the photosensitive drum 2 into toner images using toner of corresponding colors. The developing units 50y, 50m, 50c, and 50k develop the electrostatic latent image formed on the photosensitive drum 2 using yellow toner, magenta toner, cyan toner, and black toner, respectively.

The developing unit 50y includes a developing roller 51y, a supply roller 52y, and a developing blade (not illustrated). The developing roller 51y is a developing agent carrier that carries toner, which is a developing agent, and rotates to supply yellow toner to the photosensitive drum 2. The supply roller 52y is a supply member that comes into contact with the developing roller 51y, and the supply roller 52y supplies yellow toner to the developing roller 51. The developing blade is a regulating member that regulates the thickness of a yellow toner layer carried by the developing roller 51y. The other developing units 50m, 50c, and 50k also include the similar developing rollers 51m, 51c, and 51k, supply rollers 52m, 52c, and 52k, and developing blades, respectively.

The toner cartridges 70y, 70m, 70c, and 70k, respectively corresponding to the developing units 50y, 50m, 50c, and 50k, are mounted to the rotary body 90. The toner cartridges 70y, 70m, 70c, and 70k respectively accommodate yellow toner, magenta toner, cyan toner, and black toner as toner that replenish the developing units 50y, 50m, 50c, and 50k.

The rotary body 90 is rotatable about the rotational axis (rotational center) 90C. In addition, the rotational axis 90C is substantially parallel to the rotational axis (rotational center) of the photosensitive drum 2. The rotary body 90 can assume a developing orientation in which one of the developing rollers 51y, 51m, 51c, and 51k faces the photosensitive drum 2 by rotating about the rotational axis 90C. The orientation in which the developing roller 51y faces the photosensitive drum 2 is referred to as a yellow developing orientation. The orientation in which the developing roller 51m faces the photosensitive drum 2 is referred to as a magenta developing orientation. Also, the orientation in which the developing roller 51c faces the photosensitive drum 2 is referred to as a cyan developing orientation. Furthermore, the orientation in which the developing roller 51k faces the photosensitive drum 2 is referred to as a black developing orientation. That is to say, the rotary body 90 can rotate about the rotational axis 90C such that the positions of the developing rollers 51y, 51m, 51c, and 51k relative to the photosensitive drum 2 change.

The apparatus body 1A includes motors M1 (not illustrated), M2 (not illustrated), and M3 as driving sources. The motor M1 supplies drive power for rotating the rotary body 90 about the rotational axis 90C. In addition, the motor M2 moves the trays 80y, 80m, 80c, and 80k relative to the rotary body 90.

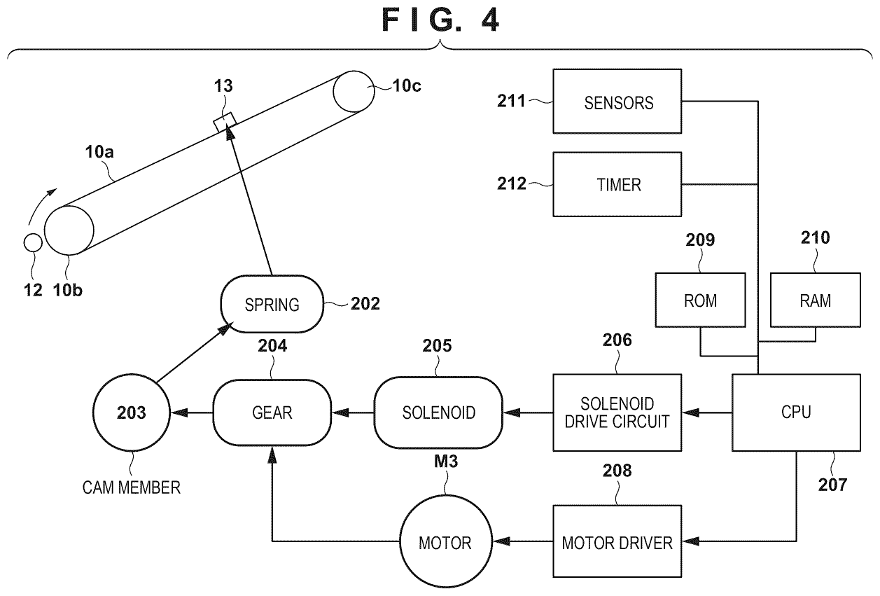

The motor M3 (FIG. 4) drives members other than members that are driven by the motor M1 and the motor M2. The motor M3 drives the photosensitive drum 2, the developing units 50y, 50m, 50c, and 50k, a pickup roller 310, a feed roller 311, a conveyance roller pair 320, a secondary transfer roller 12, a belt drive roller 10b, and a fixing unit (fixing device) 40, for example. Furthermore, the motor M3 is used for driving a contact/separation operation of the secondary transfer roller 12 and an intermediate transfer belt cleaning device (cleaning portion) 13 relative to an intermediate transfer belt 10a. Note that the motor M3 may include a plurality of motors, and members that are driven by the motors M1, M2, and M3 can be changed as appropriate. In addition, it is also possible to integrate the functions of any two or all of the three motors M1, M2, and M3 into one motor. On the other hand, a driving source different from the motors M1, M2, and M3 may be added.

Here, the subscripts “y”, “m”, “c”, and “k” of the reference signs for the developing units 50y, 50m, 50c, and 50k, the toner cartridges 70y, 70m, 70c, and 70k, the trays 80y, 80m, 80c, and 80k, and the like respectively indicate the colors of toner of the corresponding units, members, and the like. Here, the subscripts “y”, “m”, “c”, and “k” respectively indicate yellow, magenta, cyan, and black. Basic configurations and functions of the developing units 50y, 50m, 50c, and 50k are the same. Basic configurations and functions of the toner cartridges 70y, 70m, 70c, and 70k are also the same. Basic configurations and functions of the trays 80y, 80m, 80c, and 80k are also the same. Therefore, when there is no need to distinguish between colors, description will be given in which a reference numeral without the subscript “y”, “m”, “c”, or “k” indicates any one of the four units, any one of the four cartridges, or any one of the four trays.

The apparatus body 1A also includes a sheet stack 300, the pickup roller 310, the feed roller 311, a separation roller 312, the conveyance roller pair 320, the secondary transfer roller 12, the fixing unit 40, and an intermediate transfer unit 10. The pickup roller 310 is an example of a feeding member for feeding sheets S. The feed roller 311 and the separation roller 312 are an example of a separation-and-conveyance unit that conveys sheets S while separating the sheets S one sheet at a time due to frictional force. The secondary transfer roller 12 is an example of a transfer member for transferring an image from the intermediate transfer belt 10a to the sheet S.

The intermediate transfer unit 10 includes the intermediate transfer belt 10a, the belt drive roller 10b, a tension roller 10c, the (intermediate transfer belt) cleaning device 13, and a primary transfer roller 11. The intermediate transfer belt 10a is an example of an intermediate transfer member that carries an image (primarily) transferred from the photosensitive drum 2, and the intermediate transfer belt 10a conveys the image in order to (secondarily) transfer the image onto the sheet S. The intermediate transfer belt 10a is stretched over the belt drive roller 10b and the tension roller 10c. The belt drive roller 10b is a driving member that conveys the intermediate transfer belt 10a by being rotated and driven by the motor M3 that is a driving source.

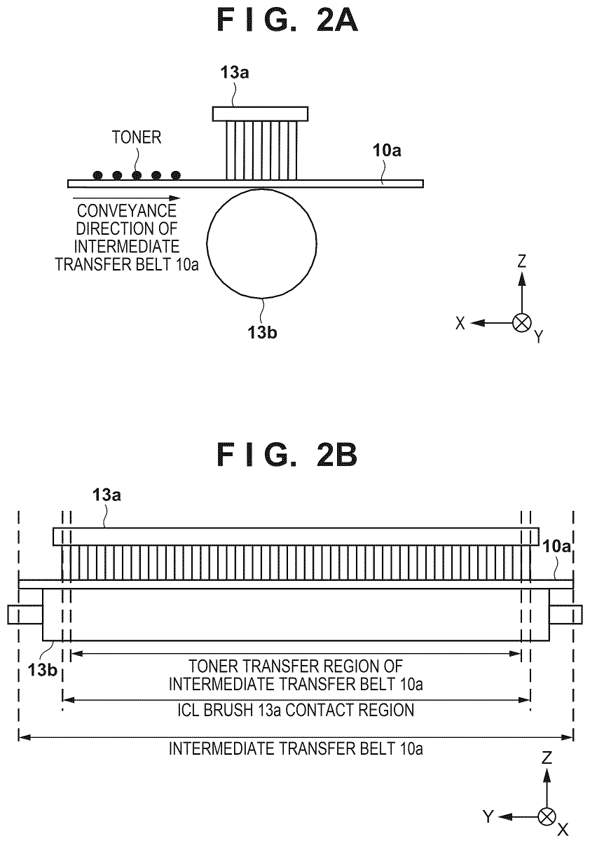

FIGS. 2A and 2B are schematic diagrams showing a schematic configuration of the cleaning device 13 for the intermediate transfer belt 10a according to the first embodiment. The intermediate transfer belt cleaning device 13 according to the first embodiment operates using the method of cleaning simultaneously with primary transfer.

FIG. 2A shows a cross-sectional configuration diagram of the intermediate transfer belt cleaning device 13 in a contact state as viewed from the Y-axis direction. The intermediate transfer belt cleaning device 13 includes an ICL brush 13a on the outer peripheral surface side of the intermediate transfer belt 10a and an ICL facing member (backup member) 13b on the inner peripheral surface side, sandwiching the intermediate transfer belt 10a. The ICL brush 13a includes a support body and brush bristles. And the ICL brush 13a has a function for charging residual toner to the polarity opposite to the charging potential of the photosensitive drum 2 and a function for entangling and temporarily holding a portion of the residual toner on the brush. Thus, the brush bristles of the ICL brush 13a according to the first embodiment are made of a conductive resin, such as nylon or rayon, and are woven onto the support body with a predetermined bristle density. Specifically, brush bristles made of a conductive nylon resin and having a length of 5 mm and a single fiber fineness of 5 dtex are woven onto a support body at a density of 100 kF/inch². The ICL facing member 13b is a cylindrical aluminum roller member, and the ICL facing member 13b rotates following the conveyance of the intermediate transfer belt 10a.

FIG. 2B is a longitudinal schematic diagram of the intermediate transfer belt cleaning device 13 as viewed from the X-axis direction.

The length in the axial direction (the Y-axis direction) of the ICL brush 13a is set such that a region in which toner is transferred onto the surface of the intermediate transfer belt 10a can be covered. Specifically, the length in the Y-axis direction of the intermediate transfer belt 10a is 236 mm, the length in the Y-axis direction of the ICL brush 13a is 224 mm, and the length in the Y-axis direction of a toner transfer region is 220 mm. In addition, the ICL brush 13a can come into contact with and separate from the intermediate transfer belt 10a.

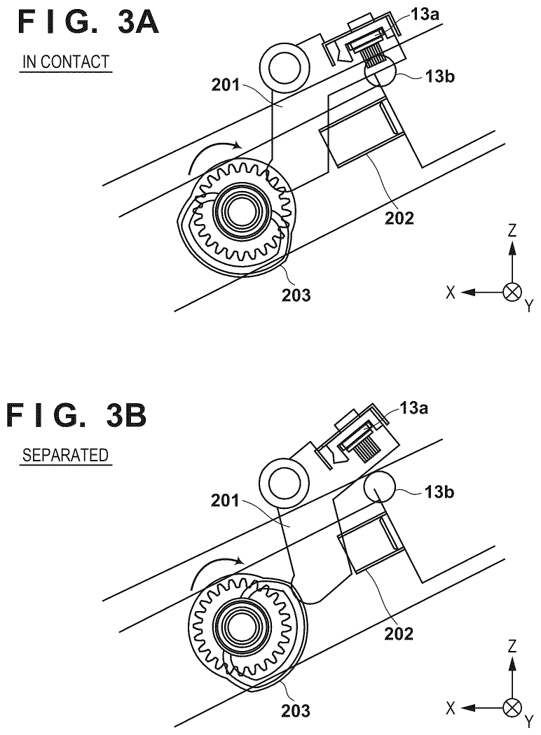

FIGS. 3A and 3B are schematic diagrams for describing a contact/separated state where the intermediate transfer belt cleaning device 13 is in contact with/separate from the intermediate transfer belt 10a according to the first embodiment.

FIG. 3A is a schematic cross-sectional diagram of a state where the ICL brush 13a is in contact with the intermediate transfer belt 10a, and FIG. 3B is a schematic cross-sectional diagram of a state where the ICL brush 13a is separate from the intermediate transfer belt 10a. The ICL brush 13a is held on a lever 201, and the lever 201 is revolvable about the Y direction that is used as a rotation axis. A spring 202 is disposed at an end portion of the lever 201 on the opposite side to a holding portion of the lever 201 where the ICL brush 13a is held, and the spring 202 presses the lever 201 in the direction in which the ICL brush 13a comes into contact with the intermediate transfer belt 10a. By the ICL brush 13a being supported due to the pressure applied by this spring 202, the ICL brush 13a can be stably brought into contact with the intermediate transfer belt 10a. In addition, by adjusting the pressure of contact of the ICL brush 13a with the intermediate transfer belt 10a using the spring 202, deformation of the brush bristles of the ICL brush 13a due to the contact can be suppressed.

In addition, as shown in FIG. 3B, by a cam member 203, which is a switching member, rotating in the arrow direction (clockwise), the lever 201 is pressed along with the spring 202, and the ICL brush 13a is moved to a position separate from the intermediate transfer belt 10a.

FIG. 4 is a diagram for describing a control unit of the image forming apparatus 1 according to the first embodiment and a configuration in which the control unit controls contact/separation of the ICL brush 13a.

The cam member 203 is coupled to a driving source by a gear train. A claw is released due to a solenoid 205 performing a suction operation for a certain period, and a final-stage gear 204 that transmits a drive force to the cam member 203 then rotates by 360 degrees by being driven by the motor M3, which is a driving source. In the first embodiment, a configuration is adopted in which, when the final-stage gear 204 rotates by 360 degrees, the cam member 203 rotates by 120 degrees. Therefore, the contact/separated state of the ICL brush 13a transitions by being driven by the solenoid 205, and the solenoid 205 is driven by a signal output by a CPU 207, which is the control unit, via a solenoid drive circuit 206. The CPU 207 also drives the motor M3 via a motor driver 208.

The CPU 207 is connected to a ROM 209, a RAM 210, sensors 211, a timer 212, and the like via a bus. The ROM 209 stores a program that is executed by the CPU 207, various types of data, and the like. The RAM 210 functions as a work memory that stores various types of data when the CPU 207 executes control processing. The sensors 211 include, for example, a later-described sensor that detects that the sheet S has reached the secondary transfer roller 12, that the sheet S has reached a nip of the fixing unit, or the like. The sensors 211 may also include a sensor that detects the presence or absence of a sheet in the sheet stack, an encoder that detects the rotation amount of the motor, and sensors that detect an environmental condition and the like. In addition, the timer 212 counts time in accordance with an instruction given by the CPU 207, and thereby notifies the CPU 207 that a predetermined time instructed by the CPU 207 has elapsed, for example.

A description will be given with reference to FIG. 1 again. The intermediate transfer belt cleaning device 13 is disposed downstream (on the tension roller 10c side) of a secondary transfer nip (a portion of contact with the secondary transfer roller 12) in the conveyance direction of the intermediate transfer belt 10a. In the first embodiment, the cleaning device 13 is disposed downstream of the central position between the belt driver roller 10b and the tension roller 10c.

Next, an image forming operation according to the first embodiment will be described. First, the photosensitive drum 2 is rotated in the arrow direction (counterclockwise) in FIG. 1 in synchronization with rotation of the intermediate transfer belt 10a. The surface of the photosensitive drum 2 is then uniformly charged by the charging roller 3.

When forming a color image on the sheet S, the rotary body 90 rotates in the arrow direction (clockwise) in FIG. 1 while supporting the developing units 50y, 50m, 50c, and 50k. An electrophotographic process is then repeatedly performed while moving the developing rollers 51y, 51m, 51c, and 51k to a development position one at a time.

First, the scanner 4 irradiates the photosensitive drum 2 with laser light that is based on image data corresponding to a yellow image, and the scanner 4 forms an electrostatic latent image corresponding to the yellow image on the surface of the photosensitive drum 2. In parallel with the formation of this electrostatic latent image, the motor M1 rotates the rotary body 90, and the rotary body 90 assumes the yellow developing orientation. When the rotary body 90 assumes the yellow developing orientation, the developing roller 51y is at the development position, and the developing roller 51y develops the electrostatic latent image formed on the photosensitive drum 2 using yellow toner. A developing voltage of the polarity opposite to the charging potential of the photosensitive drum 2 is applied to the developing roller 51y such that toner adheres to the latent image on the photosensitive drum 2.

In the first embodiment, the developing rollers 51y, 51m, 51c, and 51k are elastic rollers with rubber coating around metal shafts. At the development position, the developing rollers 51y, 51m, 51c, and 51k each develop the electrostatic latent image in a state of being in contact with the photosensitive drum 2. That is to say, the image forming apparatus 1 according to the first embodiment adopts a contact development method. However, at the development position, the developing rollers 51y, 51m, 51c, and 51k may each develop the electrostatic latent image with a gap between the photosensitive drum 2 and the developing roller 51y, 51m, 51c, or 51k. That is to say, the image forming apparatus 1 may adopt a non-contact development method.

When a yellow toner image is developed, the yellow toner image on the photosensitive drum 2 is primarily transferred onto the intermediate transfer belt 10a by the primary transfer roller 11 disposed on the inner side of the intermediate transfer belt 10a. At this time, a primary transfer voltage of the polarity opposite to the toner image formed on the photosensitive drum 2 is applied to the primary transfer roller 11.

From this point on, by rotating the rotary body 90 and moving the developing rollers 51m, 51c, and 51k to the development position in order, toner images of the respective colors are sequentially formed on the photosensitive drum 2. Specifically, after a yellow toner image is transferred onto the intermediate transfer belt 10a, the rotary body 90 assumes the magenta developing orientation, and a magenta toner image is transferred over the yellow image onto the intermediate transfer belt 10a. After the magenta toner image is transferred onto the intermediate transfer belt 10a, the rotary body 90 assumes the cyan developing orientation, and a cyan toner image is transferred onto the intermediate transfer belt 10a. After the cyan toner image is transferred over a toner image of yellow and magenta onto the intermediate transfer belt 10a, the rotary body 90 assumes the black developing orientation, and a black toner image starts to be formed on the intermediate transfer belt 10a. During a period until when the image of yellow, magenta, and cyan formed on the intermediate transfer belt 10a passes the secondary transfer portion and the cleaning device, the secondary transfer roller 12 and the intermediate transfer belt cleaning device 13 are in a separated state of not being in contact with the intermediate transfer belt 10a. The secondary transfer roller 12 comes into contact with the intermediate transfer belt 10a during a period from when the toner image of yellow, magenta, and cyan formed on the intermediate transfer belt 10a passed the secondary transfer portion until when the leading edge of the color toner image on the intermediate transfer belt 10a, on which the toner image of the fourth color, namely a black toner image, has been transformed over the toner image of yellow, magenta and cyan, reaches the secondary transfer portion again.

On the other hand, sheets S are fed from the sheet stack 300 provided on the lower side of the apparatus body 1A by the pickup roller 310. The sheets S are sent to the conveyance roller pair 320 in a state of being separated as individual sheets by the feed roller 311 and the separation roller 312. Each of the sheets S sent to the conveyance roller pair 320 waits until the toner image is formed on the above intermediate transfer belt 10a. After the toner image is formed on the intermediate transfer belt 10a, the sheet S, which has been held in standby at the conveyance roller pair 320, is conveyed, and the sheet S is sent to the transfer portion (secondary transfer portion) that is the nip portion between the intermediate transfer belt 10a and the secondary transfer roller 12. In this manner, the color image on the intermediate transfer belt 10a is (secondarily) transferred onto the surface of the conveyed sheet S. At this time, a secondary transfer voltage of the polarity opposite to the charging potential of the toner image is applied to the secondary transfer roller 12.

In this manner, the sheet S onto which the color image has been transferred is sent to the fixing unit 40. The sheet S is heated and pressurized in the fixing unit 40, and the image is fixed to the sheet S. The sheet S that has passed the fixing unit 40 is discharged as a product to the outside of the image forming apparatus 1.

Residual toner remaining on the surface of the intermediate transfer belt 10a after the secondary transfer is cleaned by the intermediate transfer belt cleaning device 13 as follows.

The ICL brush 13a has a function for charging residual toner on the intermediate transfer belt 10a to the polarity opposite to the charging potential of the photosensitive drum 2 and has a function for temporarily holding a part of residual toner by entangling the part of the residual toner on the brush. The residual toner on the intermediate transfer belt 10a is charged to the polarity opposite to the charging potential of the photosensitive drum 2 by passing the ICL brush 13a. Since the photosensitive drum 2 in the first embodiment is negatively charged and a positive voltage is applied to the ICL brush 13a, residual toner that has passed the ICL brush 13a is positively charged. The residual toner positively charged in this manner moves to the negatively charged surface of the photosensitive drum 2 at the primary transfer nip and is collected by the cleaning unit 6 for the photosensitive drum 2.

On the other hand, residual toner temporarily held on the ICL brush 13a without passing the ICL brush 13a is discharged from the ICL brush 13a onto the intermediate transfer belt 10a again in an operation after image formation. At the primary transfer nip, the residual toner then moves to the surface of the photosensitive drum 2 and is collected by the photosensitive drum cleaning unit 6. Note that all of the toner temporarily held on the ICL brush 13a is not discharged to the intermediate transfer belt 10a, and a certain amount of residual toner after secondary transfer is still held on the ICL brush 13a.

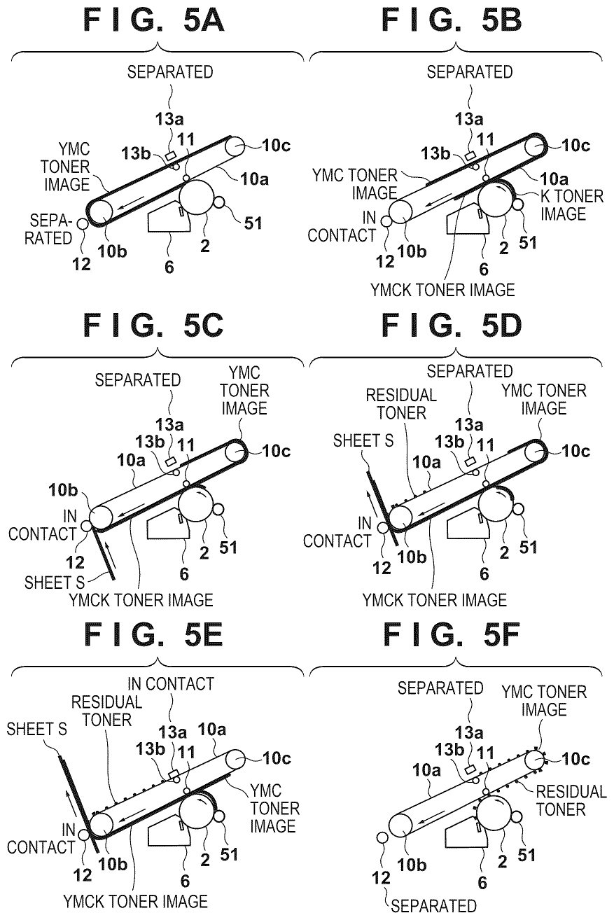

Next, contact/separation timings of the ICL brush 13a according to the first embodiment will be described with reference to FIGS. 5A to 5F.

FIGS. 5A to 5F are schematic cross-sectional diagrams illustrating the position of a toner image on the intermediate transfer belt 10a, the position of the sheet S, and a contact/separated state of the ICL brush 13a in the image forming apparatus 1 according to the first embodiment.

FIG. 5A shows a state from when primary transfer of yellow, magenta, and cyan position toner images onto the intermediate transfer belt 10a is complete until when a YMC toner image of yellow, magenta and cyan on the intermediate transfer belt 10a passes the intermediate transfer belt cleaning device 13 (the ICL brush 13a and the ICL facing member 13b). At this time, the ICL brush 13a is in a separated state of not being in contact with the intermediate transfer belt 10a.

FIG. 5B shows a state where the YMC toner image formed on the intermediate transfer belt 10a passes the secondary transfer portion, and a toner image of a fourth color, namely black (K toner image) is started to be transferred over the YMC toner image onto the intermediate transfer belt 10a. At this time, the secondary transfer roller 12 is in contact with the intermediate transfer belt 10a until a YMCK toner image of yellow, magenta, cyan, and black reaches the secondary transfer portion.

FIG. 5C shows a state where, after the secondary transfer roller 12 came into contact with the intermediate transfer belt 10a, the sheet S held in standby until the YMCK toner image formed on the intermediate transfer belt 10a is conveyed in synchronization with the toner image on the intermediate transfer belt 10a and reaches the secondary transfer nip. At this time, the ICL brush 13a is still in a state of being separate from the intermediate transfer belt 10a. Secondary transfer of the YMCK toner image onto the sheet S is started in this manner.

FIG. 5D shows a state where secondary transfer is being performed while the sheet S is passing the secondary transfer nip. At this time, the ICL brush 13a is still in a state of being separate from the intermediate transfer belt 10a.

FIG. 5E shows a state until residual toner remaining on the surface of the intermediate transfer belt 10a reaches the intermediate transfer belt cleaning device 13 in the state where secondary transfer is being performed while the sheet S is passing the secondary transfer nip. At this time, the ICL brush 13a is in a state of being in contact with the intermediate transfer belt 10a.

FIG. 5F shows a state where residual toner has passed the intermediate transfer belt cleaning device 13, and the ICL brush 13a separates from the intermediate transfer belt 10a again and prepares for the next image formation.

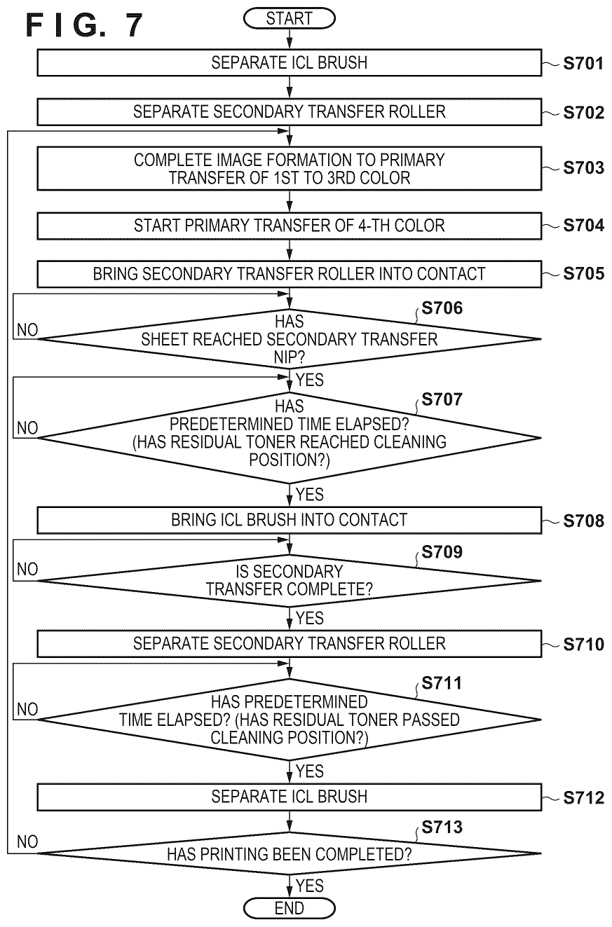

FIG. 7 is a flowchart for describing contact/separation control of the ICL brush 13a that is performed in the image forming apparatus 1 according to the first embodiment. Note that processing described in this flowchart is realized by the CPU 207 executing a program stored in the ROM 209. Note that, in this flowchart, a part of control processing that is performed by the CPU 207 and is mainly related to contact/separation control of the ICL brush 13a will be described, and processing related to the other parts of the processing is omitted.

The processing described in the flowchart in FIG. 7 is started by starting image formation, and, first, in step S701, the CPU 207 separates the ICL brush 13a from the intermediate transfer belt 10a by driving the above solenoid 205, motor M3, and the like. Next, the processing advances to step S702, where the CPU 207 separates the secondary transfer roller 12 from the intermediate transfer belt 10a. Note that, if the ICL brush 13a and the secondary transfer roller 12 are separate from the intermediate transfer belt 10a from the beginning, these steps S701 and S702 may be omitted.

Next, the processing advances to step S703, where the CPU 207 executes primary transfer of yellow, magenta, and cyan toner images onto the intermediate transfer belt 10a, and the processing then advances to step S704, where the CPU 207 starts primary transfer of a toner image of the fourth color, namely black onto the intermediate transfer belt 10a. The processing then advances to step S705, where the CPU 207 brings the secondary transfer roller 12 into contact with the intermediate transfer belt 10a and starts to convey the sheet S in synchronization with primary transfer of the toner image of the fourth color, namely black. In step S706, when the leading edge of the sheet S reaches the secondary transfer nip in synchronization with primary transfer of the black toner image, the CPU 207 starts secondary transfer onto the sheet S using the secondary transfer roller 12, and the processing advances to step S707. Note that determination as to whether or not the leading edge of the sheet S has reached the secondary transfer nip may be performed based on a result of detection performed by the aforementioned sensor. The processing then advances to step S707, where the CPU 207 determines whether or not a predetermined time has elapsed from when secondary transfer was started, in other words, whether or not a timing for residual toner remaining on the surface of the intermediate transfer belt 10a to reach the intermediate transfer belt cleaning device 13 (the state in FIG. 5E) has come in a state where secondary transfer onto the sheet S is being performed. Determination on this timing may be performed by obtaining a time from when secondary transfer was started until when residual toner reaches the cleaning device 13 with respect to the rotation speed of the motor M3 or the like by conducting tests in advance, for example, and determining whether or not the timer 212 has counted the obtained time. Also, the determination on the timing may also be performed by obtaining the rotation amount of the motor M3 from when secondary transfer was started until when residual toner reaches the cleaning device 13 and by determining whether or not the rotation amount of the actually rotating and driving motor has reached the obtained rotation amount.

In step S707, if it is determined, in this manner, that the timing for residual toner to reach the cleaning device 13 after the secondary transfer was started has come, the processing advances to step S708, where the CPU 207 brings the ICL brush 13a into contact with the intermediate transfer belt 10a by driving the above solenoid 205 and the motor M3. Accordingly, the aforementioned state shown in FIG. 5E is entered. The processing then advances to step S709, where the CPU 207 waits until the secondary transfer onto the sheet S is complete, and the processing advances to step S710, where the CPU 207 separates the secondary transfer roller 12 from the intermediate transfer belt 10a. The processing then advances to step S711, where the CPU 207 determines whether or not a predetermined time has elapsed from when the secondary transfer onto the sheet S was complete, in other words, whether or not a timing for residual toner remaining on the surface of the intermediate transfer belt 10a after the secondary transfer to have passed the intermediate transfer belt cleaning device 13 has come. If it is determined, in this manner, that the residual toner has passed the intermediate transfer belt cleaning device 13, the processing advances to step S712, where the CPU 207 separates the ICL brush 13a from the intermediate transfer belt 10a by driving the above solenoid 205 and the motor M3 (FIG. 5F). Note that, similarly, also the determination in step S711 as to whether or not the predetermined time has elapsed may be performed by obtaining a time from when the secondary transfer was complete until when residual toner passes the cleaning device 13 with respect to the rotation speed of the motor or the like by conducting tests in advance, for example, and determining whether or not the timer 212 has counted the obtained time. Also, a configuration may also be adopted in which the rotation amount of the motor M3 from when the secondary transfer was complete until when residual toner has passed the cleaning device 13 is obtained in advance, and the determination is performed based on whether or not the actual rotation amount has reached the obtained rotation amount. The processing then advances to step S713, where the CPU 207 determines whether or not the entire printing has been completed, and the CPU 207 ends this processing if the entire printing has been completed-otherwise the processing advances to step S703, where the CPU 207 executes image formation on the next sheet S.

As described above, according to the first embodiment, the ICL brush 13a is brought into contact with the intermediate transfer belt 10a after the sheet S has reached the secondary transfer nip. When the sheet S enters the secondary transfer nip portion, a frictional force that acts on the intermediate transfer belt 10a at the secondary transfer portion changes substantially. This rapidly changes the conveyance speed of the intermediate transfer belt 10a. For this reason, if the ICL brush 13a is in contact with the intermediate transfer belt 10a when the sheet S enters the secondary transfer nip portion, there is the possibility that the toner accumulated on the ICL brush 13a will unintentionally scatter onto the intermediate transfer belt 10a. In this state, the polarity of the toner that has scattered onto the intermediate transfer belt 10a cannot be controlled, which inhibits primary transfer for the next page in continuous printing, at the primary transfer nip portion. Furthermore, if the scattered toner remains on the intermediate transfer belt 10a as is without moving to the photosensitive drum 2, the result becomes noticeable as an image defect in printed output.

Conventionally, a configuration is adopted in which the belt driver roller 10b, that is a facing member in secondary transfer, also functions as a backup member for an ICL brush and is disposed immediately after a secondary transfer nip. In this configuration, in consideration of an operation time of a contact/separation mechanism of the ICL brush, if the ICL brush is not brought into contact with an intermediate transfer belt before the sheet S reaches a secondary transfer portion, the conveyed sheet S fails to be in time for cleaning of residual toner after the secondary transfer.

However, the intermediate transfer belt cleaning device 13 according to the first embodiment is disposed at a position further on the downstream side of the intermediate transfer belt than the belt driver roller 10b that is a facing member for the secondary transfer, and the intermediate transfer belt cleaning device 13 is not used as a backup member. That is to say, it is possible to ensure a time required for bringing the ICL brush into contact (a time required for residual toner to reach the ICL brush 13a from the secondary transfer portion) after the sheet S enters the secondary transfer nip.

Thus, according to the first embodiment, the ICL brush is brought into contact with the intermediate transfer belt after the sheet S has reached the secondary transfer nip, and thus it is possible to prevent scattering of toner from the ICL brush caused by a change in the conveyance speed of the intermediate transfer belt when the sheet S enters the secondary transfer nip portion. Accordingly, the first embodiment has an effect of providing an output article having a favorable image quality without being affected by scattering of toner from the ICL brush.

The first embodiment has been described using color printing image formation as an example, but similar actions and effects are also achieved in monochrome printing image formation, which is not excluded from some embodiments. In addition, a configuration in which the ICL brush is separated from the intermediate transfer belt also has an effect of improving the durability of the intermediate transfer belt, and the ICL brush and the intermediate transfer belt are preferably in a separated state wherever possible. Thus, also in monochrome printing, there is an issue of unintended scattering of toner to the intermediate transfer belt due to contact/separation of the ICL brush, and in the configuration of the present disclosure, similar actions and effects are achieved.

In addition, in the first embodiment, an image forming apparatus that performs multi-stage development using a single photosensitive drum has been described as an example, but similar actions and effects are also achieved using an image forming apparatus that uses a so-called in-line method and performs image forming using photosensitive drums of the respective colors arranged on an intermediate transfer belt, which is not excluded from the scope of some embodiments.

### Second Embodiment

Next, a second embodiment of the present disclosure will be described. Basic configurations and operations of an image forming apparatus according to the second embodiment are the same as the first embodiment. Therefore, elements having a function or configuration that is the same as or equivalent to the image forming apparatus 1 according to the first embodiment are given the same reference numerals, and a detailed description is omitted. In the second embodiment, an operation of bringing the ICL brush 13a into contact with the intermediate transfer belt 10a is performed after the sheet S has reached a fixing nip.

As described in the first embodiment, unintended scattering of toner from the ICL brush 13a onto the intermediate transfer belt 10a is likely to occur when the conveyance speed of the intermediate transfer belt 10a rapidly changes. The timing when the sheet S reaches the secondary transfer nip is an example of the change, which has been described in the first embodiment. The fixing unit 40 is disposed on the downstream side of a conveyance route of the sheet S, and, even at the timing at which the sheet S reaches the fixing unit 40, there are cases where the intermediate transfer belt 10a is subjected to a rapid change in the conveyance speed.

In recent years, in order to reduce the size of an image forming apparatus, the distance from a secondary transfer portion to a fixing unit has decreased, and the shock when the sheet S enters the fixing unit and a change in a conveyance speed of the sheet S are likely to be transmitted to an intermediate transfer belt. In such an image forming apparatus, scattering of toner from the ICL brush 13a can be prevented by performing an operation of bringing the ICL brush 13a into contact with the intermediate transfer belt 10a after the sheet S has reached the fixing nip.

Next, the image forming apparatus and image forming operation according to the second embodiment will be described.

The sheet S onto which a toner image has been transferred at the secondary transfer nip is sent to the fixing unit 40 (FIG. 1). In the fixing unit 40, the sheet S is heated and pressurized, and an image is fixed to the sheet S.

The fixing unit 40 according to the second embodiment includes a pressing roller (pressing body) 401 and a fixing film (fixing rotary body) 402 as shown in FIG. 1. The pressing roller 401 and the fixing film 402 are pressed against each other, thus forming a fixing nip portion. In addition, a heater member, which is a heat source, is disposed on the inner side of the fixing film 402, and, as a result of the heater member heating the fixing film 402, a toner image on the sheet S passing the fixing nip portion is heated and pressurized, thereby being fixed. The pressing roller 401 has an elastic layer made of a heat-resistant material and formed on a metal core that is a base material, and the pressing roller 401 ensures a fixing nip width by being pressurized against the fixing film 402. In addition, the pressing roller 401 is driven and rotated in the arrow direction (counterclockwise) due to a drive force transmitted from the motor M3 by a gear provided at a metal core end. Furthermore, the fixing film 402 rotates following a frictional force generated at the nip portion between the pressing roller 401 and the fixing film 402.

The rotation speed of the pressing roller 401 is set to a speed corresponding to the speed at which the sheet S onto which a toner image has been transferred at the secondary transfer nip is conveyed. In the second embodiment, the driving source of the pressing roller 401 and the driving source of the belt driver roller 10b that drives the intermediate transfer belt 10a are the same, namely the motor M3. Therefore, those speeds are adjusted to be equivalent to each other based on the gear ratio. However, the pressing roller 401 is pressurized by the fixing film 402, and the rotation speed thereof varies according to a degree to which the pressing roller 401 is heated. This is because the elastic layer of the pressing roller 401 according to the second embodiment is formed of a silicone rubber and the outer diameter of the pressing roller 401 changes due to thermal expansion of the elastic layer. For this reason, the conveyance speed of the pressing roller 401 and the conveyance speed of the intermediate transfer belt 10a differ depending on a degree to which the pressing roller 401 is heated. Accordingly, when the sheet S onto which a toner image has been transferred at the secondary transfer nip enters the fixing nip, the conveyance speed of the sheet S changes to some extent. This change in the speed of the sheet S is transmitted to the intermediate transfer belt 10a at the secondary transfer nip, and, as a result, the conveyance speed of the intermediate transfer belt 10a also changes. Therefore, if the ICL brush 13a is in contact with the intermediate transfer belt 10a when the sheet S enters the fixing nip, there is the possibility that toner accumulated on the ICL brush 13a will unintentionally scatter onto the intermediate transfer belt 10a. In order to prevent this scattering of toner from the ICL brush 13a, an operation of bringing the ICL brush 13a into contact with the intermediate transfer belt 10a is performed after the sheet S has reached the fixing nip.

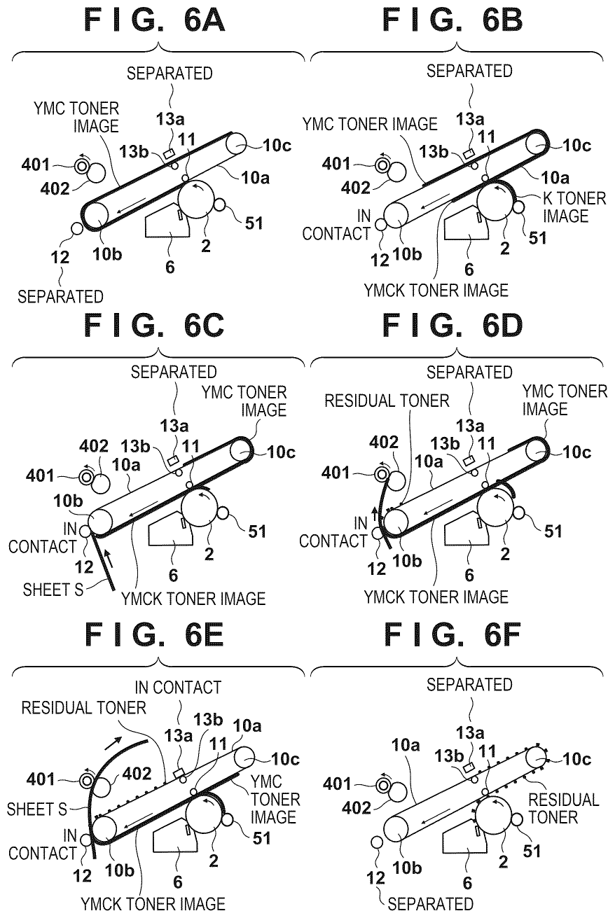

Next, contact and separation timings of the ICL brush 13a according to the second embodiment will be described with reference to FIGS. 6A to 6F.

FIGS. 6A to 6F are schematic cross-sectional diagrams illustrating the position of a toner image on the intermediate transfer belt 10a, the position of the sheet S, and a contact/separated state of the ICL brush 13a in the image forming apparatus 1 according to the second embodiment.

FIG. 6A shows a state from when primary transfer of yellow, magenta, and cyan toner images onto the intermediate transfer belt 10a was complete until when a YMC toner image of yellow, magenta, and cyan on the intermediate transfer belt 10a passes the intermediate transfer belt cleaning device 13. At this time, the ICL brush 13a is in a separated state of not being in contact with the intermediate transfer belt 10a.

FIG. 6B shows a state where the YMC toner image of yellow, magenta, and cyan formed on the intermediate transfer belt 10a passes the secondary transfer portion, and a toner image of the fourth color, namely black, has started to be transferred onto the intermediate transfer belt 10a. At this time, the secondary transfer roller 12 is in contact with the intermediate transfer belt 10a until the YMC toner image reaches the secondary transfer portion.

FIG. 6C shows a state where, after the secondary transfer roller 12 was brought into contact with the intermediate transfer belt 10a, the sheet S, held on standby until the YMCK toner image is formed on the intermediate transfer belt 10a, was conveyed in synchronization with the YMCK toner image on the intermediate transfer belt 10a, and, as a result, the sheet S has reached the secondary transfer nip. At this time, the ICL brush 13a is still in a separated state of being separate from the intermediate transfer belt 10a.

FIG. 6D shows a state where secondary transfer onto the sheet S was started, and the sheet S has passed the secondary transfer nip and reached the fixing nip. At this time, the ICL brush 13a is still in the separated state of being separate from the intermediate transfer belt 10a.

FIG. 6E shows a state until residual toner remaining on the surface of the intermediate transfer belt 10a reaches the intermediate transfer belt cleaning device 13 in a state where the sheet S is passing the fixing nip, and, at this time, the ICL brush 13a is in contact with the intermediate transfer belt 10a.

FIG. 6F shows a state where residual toner has passed the intermediate transfer belt cleaning device 13, and, at this time, the ICL brush 13a separates from the intermediate transfer belt 10a again and prepares for the next image formation.

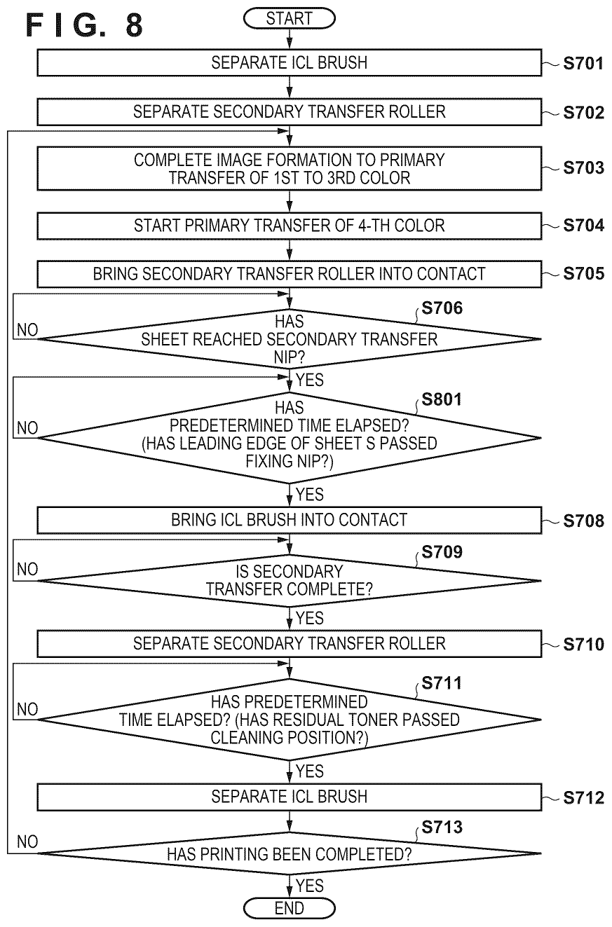

FIG. 8 is a flowchart for describing contact/separation control of the ICL brush 13a that is performed in the image forming apparatus 1 according to the second embodiment. Note that processing described in this flowchart is realized by the CPU 207 executing a program stored in the ROM 209. Note that, in FIG. 8, processing steps that are the same as processing steps in FIG. 7 are indicated by the same reference numerals, and descriptions thereof may be omitted.

In step S706, the CPU 207 starts secondary transfer onto the sheet S using the secondary transfer roller 12 when the leading edge of the sheet S reaches the secondary transfer nip. The processing then advances to step S801, where the CPU 207 determines whether or not a predetermined time has elapsed from when secondary transfer was started, in other words, whether or not a timing for the leading edge of the sheet S to pass the fixing nip in a state where secondary transfer onto the sheet S is being performed has come. Determination on this timing can be performed by the aforementioned sensor detecting that the leading edge of the sheet S has passed the fixing nip, for example. Also, determination on this timing may be performed by obtaining a time (predetermined time) from when secondary transfer was started until when the leading edge of the sheet S passes the fixing nip of the fixing unit 40, with respect to the rotation amount of the motor or the like by conducting tests, for example, and determining whether or not a time counted by the timer 212 after secondary transfer was started has reached the obtained predetermined time. Also, determination on the timing may be performed by obtaining, in advance, the rotation amount of the motor from when secondary transfer was started until when the leading edge of the sheet S reaches the fixing unit 40 and by determining whether or not the rotation amount of the motor from when secondary transfer was started has reached the obtained rotation amount using the aforementioned sensor such as an encoder. In this manner, in step S801, if the CPU 207 determines that the leading edge of the sheet S has passed the fixing nip, the processing advances to step S708, where the CPU 207 brings the ICL brush 13a into contact with the intermediate transfer belt 10a by driving the above solenoid 205 and motor M3 (FIG. 6E). Note that, here, it is based on the assumption that the distance from the secondary transfer nip to the ICL brush 13a is longer than the distance from the secondary transfer nip to the fixing unit 40. Therefore, in step S708, the ICL brush 13a may be brought into contact with the intermediate transfer belt 10a after a short time period from when the sheet S reached the fixing nip.

As described above, according to the second embodiment, an ICL brush can be brought into contact with an intermediate transfer belt after the sheet S has reached a fixing nip. Accordingly, even if the conveyance speed of the intermediate transfer belt rapidly changes due to the sheet S reaching the fixing nip, it is possible to prevent scattering of toner from the ICL brush to the intermediate transfer belt.

The intermediate transfer belt cleaning device 13 according to the second embodiment is disposed at a position such that the distance between the intermediate transfer belt cleaning device 13 and the secondary transfer nip on the intermediate transfer belt 10a is longer than the distance between the fixing unit 40 and the secondary transfer nip on the conveyance route of the sheet S. Here, the conveyance speed of the sheet S and the conveyance speed of the intermediate transfer belt 10a are the same, and thus, by adopting such arrangement, the sheet S reaches the fixing unit before residual toner left at the secondary transfer nip reaches the ICL brush 13a. That is to say, the ICL brush 13a can be brought into contact with the intermediate transfer belt 10a after the sheet S has reached the fixing nip. This makes it possible to provide a printed product of favorable image quality without toner scattering from the ICL brush 13a to the intermediate transfer belt 10a even if the conveyance speed of the intermediate transfer belt 10a changes.

In addition, in the second embodiment, the driving source of the pressing roller that is a fixing member and the driving source of the belt driver roller 10b that drives the intermediate transfer belt 10a are the same, namely the motor M3, but even in a configuration in which the pressing roller and the belt driver roller 10b have different driving sources, similar actions and effects are achieved. For this reason, such a configuration is not excluded from the scope of the present some embodiments. This is because, even in a configuration in which different driving sources are used, it is difficult to completely match the conveyance speed of the pressing roller and the conveyance speed of the intermediate transfer belt due to variation in the outer diameters of components, extents of thermal expansion of components, and the like. In addition, in the second embodiment, a configuration is adopted in which the fixing unit 40 includes a heater on the inner side of the fixing film, but similar actions and effects are achieved when a fixing configuration that uses a heat roller, a fixing configuration that uses an external heating method, a fixing configuration that uses an IH (induction heating) method, or the like is adopted, which are not excluded from the scope of some embodiments.

### Other Embodiments

Embodiments of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer-executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-074036, which was filed on Apr. 30, 2024 and which is hereby incorporated by reference herein in its entirety.

What is claimed is:

1. An image forming apparatus comprising:
one or more controllers including one or more processors and one or more memories;
an image carrier that is configured to carry a toner image;
a secondary transfer roller that is configured to perform secondary transfer of a toner image primarily transferred from the image carrier to an intermediate transfer member, from the intermediate transfer member to a printing medium; and
a cleaning device configured to be capable of coming into contact with and separating from the intermediate transfer member and to charge and clean toner remaining on the intermediate transfer member after the secondary transfer, the cleaning device including a brush member for charging the toner in accordance with an applied voltage, the brush member holding toner on a surface of a region thereof that comes into contact with the intermediate transfer member,
wherein the one or more controllers perform control so as to bring the cleaning device into contact with the intermediate transfer member after a leading edge of the printing medium has passed a contact portion between the secondary transfer roller and the intermediate transfer member.

2. The image forming apparatus according to claim 1, further comprising:
a motor that is a driving source for conveying the intermediate transfer member; and
a sensor that detects that the printing medium has reached the secondary transfer roller,
wherein the one or more controllers drive the motor by a predetermined rotation amount after the sensor has detected the printing medium to bring the cleaning device into contact with the intermediate transfer member.

3. An image forming apparatus comprising:
one or more controllers including one or more processors and one or more memories;
an image carrier that is configured to carry a toner image;
a transfer unit configured to primarily transfer a toner image formed on the image carrier onto an intermediate transfer member;
a secondary transfer roller that is configured to perform secondary transfer of the toner image from the intermediate transfer member onto a printing medium;
a cleaning device configured to be capable of coming into contact with and separating from the intermediate transfer member and to charge and clean toner remaining on the intermediate transfer member after the secondary transfer; and
a fixing device configured to fix the toner image, secondarily transferred onto the printing medium, to the printing medium by heating and pressurizing the toner image at a fixing nip portion formed between a fixing rotary body and a pressing body pressed against each other,
wherein the one or more controllers perform control so as to bring the cleaning device into contact with the intermediate transfer member after a leading edge of the printing medium secondarily transferred by the secondary transfer unit has passed the fixing nip portion of the fixing device.

4. The image forming apparatus according to claim 3, wherein the cleaning device includes a brush member for charging toner remaining on the intermediate transfer member in accordance with a voltage being applied, after the secondary transfer.

5. The image forming apparatus according to claim 3, wherein a distance from the secondary transfer roller to the cleaning device on the intermediate transfer member is longer than a distance from the secondary transfer roller to the fixing device.

6. The image forming apparatus according to claim 5, further comprising
a sensor that detects that the printing medium has passed the fixing nip portion of the fixing device,
wherein the one or more controllers bring the cleaning device into contact with the intermediate transfer member based on detection performed by the sensor.

7. The image forming apparatus according to claim 3, wherein the cleaning device holds toner on a surface of a region thereof that comes into contact with the intermediate transfer member.
